(19) United States
(12) Patent Application Publication
(10) Pub. No.: US 2013/0017455 A1
(43) Pub. Date: Jan. 17, 2013

(54) NON-AQUEOUS ELECTROLYTE AND NON-AQUEOUS ELECTROLYTE SECONDARY BATTERY USING THE SAME

(71) Applicants: Masaki Deguchi, Hyogo (JP); Shinji Kasamatsu, Hyogo (JP)

(72) Inventors: Masaki Deguchi, Hyogo (JP); Shinji Kasamatsu, Hyogo (JP)

(73) Assignee: PANASONIC CORPORATION, Kadoma-shi, Osaka (JP)

(21) Appl. No.: 13/637,605

(22) PCT Filed: Mar. 10, 2011
(86) PCT No.: PCT/JP2011/001415

§ 371 Date: Sep. 26, 2012

(30) Foreign Application Priority Data
Mar. 26, 2010 (JP) 2010-072694

(51) Int. Cl. H01M 10/0569; H01M 10/0567

(52) U.S. Cl. 429/331

(57) ABSTRACT

Disclosed is a non-aqueous electrolyte including a non-aqueous solvent, and a solute dissolved in the non-aqueous solvent. The non-aqueous solvent contains ethylene carbonate (EC), propylene carbonate (PC), diethyl carbonate (DEC), and an additive. The weight percentage W_{EC} of EC the total weight of EC, PC, and DEC is more than 20 wt % and equal to or less than 35 wt %; the weight percentage W_{PC} of PC is 20 to 40 wt %; and the weight percentage W_{DEC} of DEC is 30 to 50 wt %. The additive contains a cyclic carbonate having a C═C unsaturated bond, and a sultone compound. The ratio W_{C}/W_{SL} of a weight percentage W_{C} of the cyclic carbonate having a C═C unsaturated bond contained in the non-aqueous electrolyte, to a weight percentage W_{SL} of the sultone compound contained in the non-aqueous electrolyte is 1 to 6.

### TECHNICAL FIELD

The present invention relates to a non-aqueous electrolyte and a non-aqueous electrolyte secondary battery, and specifically relates to the composition of a non-aqueous electrolyte.

### BACKGROUND ART

Non-aqueous electrolyte secondary batteries represented by lithium ion secondary batteries include a non-aqueous electrolyte containing a non-aqueous solvent and a solute dissolved therein. For example, lithium hexafluorophosphate (LiPF₆) or lithium tetrafluoroborate (LiBF₄) is used as the solute.

The non-aqueous solvent often contains a chain carbonate which is likely to generate gas but has a low viscosity, and a cyclic carbonate which has a comparatively high viscosity but is high in polarity. For example, diethyl carbonate (DEC) is used as the chain carbonate. For example, ethylene carbonate (EC) or propylene carbonate (PC) is used as the cyclic carbonate. Cyclic carbonates such as EC and PC have a high dielectric constant, and are advantageous in achieving excellent lithium ion conductivity. Cyclic carbonates, however, have a comparatively high viscosity, and therefore, are often used by being mixed with a chain carbonate with low viscosity such as DEC. Other than the above non-aqueous solvent, a non-aqueous solvent containing a cyclic carboxylic acid ester, chain ether, and cyclic ether is generally used.

The non-aqueous electrolyte tends to decompose on the electrodes in association with charge and discharge, to generate gas. In order to solve this, Patent Literature 1 proposes a non-aqueous electrolyte prepared by adding vinylene carbonate (VC) or 1,3-propane sultone (PS) to a non-aqueous solvent containing PC, EC, and DEC. VC and PC form a stable surface film on the surface of the negative electrode, and thereby suppress the decomposition of the non-aqueous electrolyte.

Patent Literature 2 proposes a non-aqueous electrolyte secondary battery in which the ratio of EC to PC is 1:1 (volume ratio), and the negative electrode active material includes mesocarbon microbeads (MCMB), instead of graphite as generally used. PC is difficult to decompose and is unlikely to generate gas, but acts to deteriorate graphite. Presumably, MCMB is used for suppressing the deterioration of graphite.

Patent Literature 3 proposes using a special carbon material having a rhombohedral crystal structure, in combination with a non-aqueous electrolyte containing 40 vol % or more of PC, and an almost equal amount of EC, and further containing less than 5 vol % of vinylene carbonate.

### CITATION LIST

### Patent Literature

[PTL 1] Japanese Laid-Open Patent Publication No. 2004-355974
[PTL 2] Japanese Laid-Open Patent Publication No. 2006-221935
[PTL 3] Japanese Laid-Open Patent Publication No. 2003-168477

### SUMMARY OF INVENTION

### Technical Problem

Patent Literature 1 discloses an example of the non-aqueous electrolyte which satisfies EC:PC:DEC=10:20:70 (volume ratio). DEC is susceptible to oxidative decomposition and reductive decomposition. When the weight ratio of DEC is large as above, the gas generation will not be suppressed sufficiently during storage in a high temperature environment or charge/discharge cycles, causing the charge/discharge capacity of the battery to decrease.

The non-aqueous electrolyte of Patent Literature 2 is free of DEC, and therefore, is unlikely to generate gas but is highly viscous. This applies to the non-aqueous electrolyte of Patent Literature 3 in which the EC content is high. A highly viscous non-aqueous electrolyte is difficult to permeate into the electrode plate and low in ion conductivity, and therefore, causes the rate characteristics, particularly at low temperatures, to be easily deteriorated. Therefore, it is desirable to lower the viscosity of the non-aqueous electrolyte.

In the case of charging a battery in a low temperature environment, when the viscosity of the non-aqueous electrolyte is excessively high, lithium is likely to deposit on the surface of the negative electrode. If a large amount of lithium is deposited, the heat resistance of the battery will deteriorate. For example, in a high temperature environment, the lithium deposited reacts with the non-aqueous electrolyte, and the battery easily generates heat excessively.

### Solution to Problem

One aspect of the present invention relates to a non-aqueous electrolyte including a non-aqueous solvent and a solute dissolved in the non-aqueous solvent. The non-aqueous solvent contains ethylene carbonate, propylene carbonate, diethyl carbonate, and an additive. The weight percentage W_{EC} of the ethylene carbonate to the total weight of the ethylene carbonate, the propylene carbonate, and the diethyl carbonate is more than 20 wt % and equal to or less than 35 wt %; the weight percentage W_{PC} of the propylene carbonate to the total weight is 25 to 40 wt %; and the weight percentage W_{DEC} of the diethyl carbonate to the total weight is 30 to 50 wt %. The additive contains a cyclic carbonate having a C═C unsaturated bond, and a sultone compound. The ratio W_{C}/W_{SL} of a weight percentage W_{C} of the cyclic carbonate having a C═C unsaturated bond contained in the non-aqueous electrolyte, to a weight percentage W_{SL} of the sultone compound contained in the non-aqueous electrolyte is 1 to 6.

Another aspect of the present invention relates to a non-aqueous electrolyte secondary battery comprising a positive electrode, a negative electrode, a separator interposed between the positive electrode and the negative electrode, and the above non-aqueous electrolyte.

### Advantageous Effects of Invention

By using the non-aqueous electrolyte of the present invention, it is possible to provide a non-aqueous electrolyte secondary battery being excellent in the storage characteristics in a high temperature environment, heat resistance after charging in a low temperature environment, and charge/discharge cycle characteristics, and having excellent low temperature characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A schematic longitudinal cross-sectional view of an exemplary non-aqueous electrolyte secondary battery according to the present invention

### DESCRIPTION OF EMBODIMENTS

The non-aqueous electrolyte of the present invention includes a non-aqueous solvent and a solute dissolved in the non-aqueous solvent.

The non-aqueous solvent contains ethylene carbonate (EC), propylene carbonate (PC), diethyl carbonate (DEC), and an additive. The additive contains a sultone compound and a cyclic carbonate having a C═C unsaturated bond. The sultone compound refers to a cyclic intramolecular ester of oxysulfonic acid.

Cyclic carbonates such as PC and EC have a higher oxidation potential than chain carbonates such as DEC. Therefore, cyclic carbonates are less likely to be oxidatively decomposed than chain carbonates. Among chain carbonates, PC has a lower melting point (melting point: −49° C.) than EC (melting point: 37° C.). Therefore, in one aspect, the larger the amount of PC is, the more advantageous it is to achieve excellent low temperature characteristics of the non-aqueous electrolyte secondary battery.

However, PC is more viscous than EC, and therefore, when the amount of PC is much larger than that of EC, the viscosity of the non-aqueous electrolyte tends to increase. When the viscosity of the non-aqueous electrolyte is excessively high, lithium is likely to deposit on the surface of the negative electrode during charging in a low temperature environment. If a large amount of lithium is deposited, the heat resistance of the battery will deteriorate.

Therefore, in the present invention, the amount of PC in the non-aqueous electrolyte is set comparatively small, and the amount of EC is increased accordingly. This makes it possible to suppress lithium deposition during charging in a low temperature environment, and improve the low temperature characteristics of the non-aqueous electrolyte secondary battery. However, EC is more easily oxidized than PC. If the weight percentage of EC is too high, a large amount of gas will be generated due to decomposition of EC at the positive electrode. Therefore, it is preferable to set the weight percentage of PC to be nearly equal to that of EC or not to be too low.

The safety standards required for non-aqueous electrolyte are very stringent in recent years. For example, in a test for the safety evaluation, a battery overcharged at a low temperature of about −5° C. is intentionally heated to about 130° C. When the amount of PC is much larger than that of EC, a sufficient level of safety may not be obtained in such a test. However, by using the non-aqueous electrolyte of the present invention, a high level of safety can be obtained even in such a test. On the other hand, when the weight percentage of PC is comparatively high, it is inevitable that the reductive decomposition of PC at the negative electrode may occur.

The non-aqueous electrolyte of the present invention includes a sultone compound and a cyclic carbonate having C═C unsaturated bond, as an additive. As such, on the positive electrode, a surface film derived from the sultone compound is formed; and on the negative electrode, a surface film derived from the cyclic carbonate having C═C unsaturated bond and a surface film derived from the sultone compound are formed. The surface film derived from the cyclic carbonate having C═C unsaturated bond can suppress the increase in the film resistance, and as a result, the charge acceptance improves. This suppresses lithium deposition on the surface of the negative electrode. Moreover, this can suppress the deterioration in the cycle characteristics. On the other hand, the sultone compound is more preferentially decomposed than PC at the negative electrode, forming a surface film thereon. The surface film derived from the sultone compound can inhibit the decomposition of PC, and as a result, the generation of gas, such as CH₄, C₃H₆, or C₃H₈ gas, is suppressed.

The weight percentage W_{EC} of EC to the total weight of EC, PC, and DEC is more than 20 wt % and equal to or less than 35 wt %. A preferred lower limit of W_{EC} is 25 wt %, and a preferred upper limit thereof is 33 wt %. As for the range of W_{EC}, these lower limits and upper limits may be combined in any combination. When the weight percentage of EC is equal to or less than 20 wt %, the amount of PC is relatively large, and the viscosity of the non-aqueous electrolyte becomes excessively high, especially at low temperatures. As a result, lithium becomes likely to deposit on the surface of the negative electrode. Furthermore, the formation of a surface film (or a solid electrolyte interface (SEI)) on the negative electrode may be insufficient, which makes it difficult for lithium ions to be absorbed in or released from the negative electrode. When the weight percentage of EC exceeds 35 wt %, especially at the positive electrode, oxidative decomposition of EC occurs, and a large amount of gas will be generated. By setting the weight percentage of EC in the non-aqueous solvent to be within the above range, it is possible to prevent the viscosity of the non-aqueous electrolyte from becoming excessively high at low temperatures and inhibit the oxidative decomposition of EC, and it is possible to sufficiently form a surface film (SEI) on the negative electrode. This significantly improves the charge/discharge capacity and rate characteristics of the non-aqueous electrolyte secondary battery.

The weight percentage W_{PC} of PC to the total weight of EC, PC, and DEC is 20 to 40 wt %. A preferred lower limit of W_{PC} is 20 wt %, and a preferred upper limit thereof is 33 wt %. As for the range of W_{PC}, these lower limit and upper limits may be combined in any combination. When the weight percentage of PC is less than 20 wt %, the amount of DEC or EC in the non-aqueous solvent is relatively large, and the gas generation is not sufficiently suppressed. When the weight percentage of PC exceeds 40 wt %, the viscosity of the non-aqueous electrolyte becomes excessively high, especially at low temperatures. As a result, lithium becomes likely to deposit on the surface of the negative electrode. Moreover, PC may be reductively decomposed at the negative electrode, and the generation of gas, such as CH₄, C₃H₆, or C₃H₈ gas, may occur. By setting the weight percentage of PC in the non-aqueous solvent to be within the above range, it is possible to prevent the viscosity of the non-aqueous electrolyte from becoming excessively high at low temperatures. In addition, it is possible to reduce the generation of gases derived from EC and DEC and inhibit the reductive decomposition of PC. Therefore, the decrease in charge/discharge capacity in a high temperature environment, and the deterioration in charge/discharge characteristics at low temperatures of the non-aqueous electrolyte secondary battery can be significantly suppressed.

The weight percentage W_{DEC} of DEC to the total weight of EC, PC, and DEC is 30 to 50 wt %. A preferred lower limit of W_{DEC} is 35 wt %, and a preferred upper limit thereof is 50 wt %. As for the range of W_{DEC}, these lower limits and upper limits may be combined in any combination. When the weight percentage of DEC is less than 30 wt %, the viscosity becomes high, and the charge/discharge characteristics at low temperatures will be easily deteriorated. When the weight percentage of DEC exceeds 50 wt %, a large amount of gas will be generated.

In one preferred embodiment of the present invention, the ratio W_{PC}/W_{EC} of the weight percentage W_{PC} of the propylene carbonate to the weight percentage W_{EC} of the ethylene carbonate is 0.5 to 1.75. When W_{PC}/W_{EC} is less than 0.5, especially at the positive electrode, the generation of gas due to oxidative decomposition of EC may increase. On the other hand, when W_{PC}/W_{EC} exceeds 1.75, especially at low temperatures, the viscosity of the non-aqueous electrolyte tends to become excessively high, and lithium may become likely to deposit on the surface of the negative electrode. Moreover, especially at the negative electrode, the generation of gas due to reductive decomposition of PC may increase. A more preferred lower limit of the ratio W_{PC}/W_{EC} of the weight percentage W_{PC} of the propylene carbonate to the weight percentage W_{EC} of the ethylene carbonate is 1, and a more preferred upper limit thereof is 1.5. As for the range of W_{PC}/W_{EC}, these lower limits and upper limits may be combined in any combination.

The ratio of the weight percentages EC, PC, and DEC is preferably W_{EC}:W_{PC}:W_{DEC}=3: (2 to 4):(3 to 5), and more preferably 3:(2 to 3):(4 to 5). The non-aqueous electrolyte in which the ratio of the weight percentages EC, PC, and DEC is within the above range has an appropriate level of viscosity, even at low temperatures. Therefore, lithium deposition on the surface of the negative electrode can be remarkably suppressed during charging in a low temperature environment.

The ratio W_{C}/W_{SL} of a weight percentage W_{C} of the cyclic carbonate having a C═C unsaturated bond to a weight percentage W_{SL} of the sultone compound in the additive is 1 to 6, and preferably 1 to 4. When W_{C}/W_{SL} is less than 1, the sultone compound excessively forms a dense surface film on the negative electrode. In this case, lithium becomes likely to deposit on the surface of the negative electrode during charging at low temperatures. Moreover, the excessive formation of a surface film derived from the sultone compound impedes the sufficient formation of an SEI derived from the cyclic carbonate having a C═C unsaturated bond. As a result, satisfactory cycle characteristics may not be obtained.

On the other hand, when W_{C}/W_{SL} exceeds 6, the cyclic carbonate having a C═C unsaturated bond is oxidatively decomposed, and a large amount of gas will be generated. Moreover, the effect of the sultone compound to suppress the reductive decomposition of PC at the negative electrode and to suppress the oxidative decomposition of the cyclic carbonate having a C═C unsaturated bond at the positive electrode will not sufficiently work. As a result, a large amount of gas is likely to be generated.

The inclusion of the cyclic carbonate having a C═C unsaturated bond in the additive allows a surface film to be predominantly formed on the negative electrode, and as a result, favorable cycle characteristics can be obtained. On the negative electrode, for example, a surface film containing polyvinylene carbonate is formed. The weight percentage W_{C} of the cyclic carbonate having a C═C unsaturated bond to the total weight of the non-aqueous electrolyte is preferably 1 to 3 wt %. A more preferred lower limit of W_{C} is 1.5 wt %, and a more preferred upper limit thereof is 2.5 wt %. As for the range of W_{C}, these lower limits and upper limits may be combined in any combination. By setting W_{C} to be equal to or more than 1 wt %, a sufficient amount of surface film is formed, and the decomposition of the non-aqueous solvent can be easily suppressed. By setting W_{C} to be equal to or less than 3 wt %, the gas generation due to oxidative decomposition of the cyclic carbonate having a C═C unsaturated bond can be easily suppressed.

Examples of the cyclic carbonate having a C═C unsaturated bond include vinylene carbonate (VC), vinylethylene carbonate (VEC), and divinylethylene carbonate (DVEC). These cyclic carbonates having a C═C unsaturated bond may be used singly or in combination of two or more. Preferred among them is vinylene carbonate because it can form a thin and dense surface film on the negative electrode, and achieve a low film resistance.

The inclusion of the sultone compound in the additive allows a surface film to be formed on the positive electrode and the negative electrode. The surface film formed on the positive electrode can suppress the oxidative decomposition of the non-aqueous solvent at the positive electrode in a high temperature environment. On the positive electrode, for example, a surface film containing lithium alkylsulfonate is formed. On the other hand, the surface film formed on the negative electrode can suppress the reductive decomposition of the non-aqueous solvent, especially of PC, at the negative electrode. On the negative electrode also, for example, a surface film containing lithium alkylsulfonate is formed. The weight percentage W_{SL} of the sultone compound to the total weight of the non-aqueous electrolyte is preferably 0.5 to 2 wt %. A more preferred lower limit of W_{SL} is 1 wt %, and a more preferred upper limit thereof is 1.5 wt %. As for the range of W_{SL}, these lower limits and upper limits may be combined in any combination. By setting W_{SL} to be equal to or more than 0.5 wt %, a sufficient amount of surface film is formed, and the decomposition of the non-aqueous solvent can be easily suppressed. By setting W_{SL} to be equal to or less than 2 wt %, a surface film is unlikely to be excessively formed on the negative electrode. Therefore, the lithium deposition on the surface of the negative electrode can be easily suppressed.

Examples of the sultone compound include 1,3-propane sultone (PS),1,4-butane sultone, and 1,3-propene sultone (PRS). These sultone compounds may be used singly or in combination of two or more. Preferred among them is 1,3-propane sultone because it can remarkably suppress the reductive decomposition of PC.

In the case of not using the sultone compound and adding only the cyclic carbonate having a C═C unsaturated bond, for example, adding only vinylene carbonate, because of its poor oxidation resistance, vinylene carbonate may be oxidatively decomposed at the positive electrode, to increase the generation of CO₂ gas. By adding the sultone compound, for example, 1,3-propane sultone, together with vinylene carbonate, a surface film derived from 1,3-propane sultone is formed on the positive electrode, and thus, the oxidative decomposition not only of the non-aqueous solvent but also of vinylene carbonate can be suppressed. As a result, the generation of gas, such as CO₂ gas, can be significantly suppressed.

The amount of the additive, that is, the total amount of the sultone compound and the cyclic carbonate having a C═C unsaturated bond, is preferably 1.5 to 5 wt %, and more preferably 2 to 4 wt % to the total amount of the non-aqueous electrolyte. By setting the total amount of the sultone compound and the cyclic carbonate having a C═C unsaturated bond to be equal to or more than 1.5 wt % to the total amount of the non-aqueous electrolyte, the effect to suppress the reductive decomposition of PC is easy to work. By setting the total amount of the sultone compound and the cyclic carbonate having a C═C unsaturated bond to be equal to or less than 5 wt % to the total amount of the non-aqueous electrolyte, a surface film is unlikely to be formed excessively on the negative electrode. Therefore, lithium deposition on the surface of the negative electrode can be sufficiently suppressed during charging especially at low temperatures.

The additive is not limited to the above sultone compound and cyclic carbonate having a C═C unsaturated bond, and may further contain another compound. The another compound is not particularly limited, and may be, for example, a cyclic sulfone such as sulfolane, a fluorine-containing compound such as fluorinated ether, or a cyclic carboxylic acid ester such as γ-butyrolactone. The weight percentage of another additive(s) in the non-aqueous electrolyte is preferably equal to or less than 10 wt %. These another additives may be used singly or in combination of two or more.

The viscosity at 25° C. of the non-aqueous electrolyte of the present invention is, for example, 4 to 6.5 mPa·s, and preferably 4.5 to 5.9 mPa·s. By setting the viscosity within the above range, lithium deposition and deterioration in rate characteristics at low temperatures can be remarkably suppressed. The viscosity of the non-aqueous electrolyte can be controlled by changing the W_{PC}/W_{EC} ratio or W_{DEC}. The viscosity is measured using a rotational viscometer and a cone plate spindle.

The solute of the non-aqueous electrolyte is not particularly limited, and may be, for example, an inorganic lithium fluoride such as LiPF₆ or LiBF₄, or a lithium imide compound such as LiN(CF₃SO₂)₂ or LiN(C₂F₅SO₂)₂.

The non-aqueous electrolyte secondary battery includes a positive electrode, a negative electrode, a separator interposed between the positive electrode and the negative electrode, and the above non-aqueous electrolyte. The non-aqueous electrolyte secondary battery is preferably subjected to charging and discharging at least once before use. The charging and discharging is preferably performed such that the potential at the negative electrode falls within the range of 0.08 to 1.4 V vs. Li/Li⁺.

The above battery can be obtained by, for example, the production method including the steps of:

(1) forming an electrode group including a positive electrode, a negative electrode, and a separator;

(2) placing the electrode group into a battery case, and injecting the above non-aqueous electrolyte into the battery case in which the electrode group is placed;

(3) after the step (2), sealing the battery case; and

(4) after the step (3), subjecting the obtained battery to charging and discharging at least once.

In the non-aqueous electrolyte secondary battery according to the present invention, particularly, the safety in a high temperature environment after charging at low temperatures is remarkably improved. In addition, the gas generation due to reaction between the non-aqueous electrolyte and the electrode is significantly suppressed, and therefore, the decrease in charge/discharge capacity and the deterioration in rate characteristics can be suppressed. It should be noted that the EC, and the sultone compound and/or the cyclic carbonate having a C═C unsaturated bond, which are included as an additive, will partially decompose, for example, during the above charging and discharging, forming a surface film on the positive and/or negative electrode. Accordingly, W_{PC}/W_{EC} in the non-aqueous electrolyte in the battery having been subjected to the above charging and discharging is, for example, 0.5 to 1.85. W_{C}/W_{SL} in the non-aqueous electrolyte in the battery having been subjected to the above charging and discharging is, for example, 0.02 to 2. The amount of the additive in the non-aqueous electrolyte included in the battery is, for example, 0.2 to 4 wt %.

The positive electrode comprises a positive electrode core material and a positive electrode material mixture layer adhering to the positive electrode core material. The positive electrode material mixture layer generally contains a positive electrode active material, a conductive material, and a binder. The positive electrode can be obtained by, for example, preparing a positive electrode material mixture slurry containing a positive electrode active material, a conducive material such as carbon black, and a binder such as polyvinylidene fluoride, and applying the slurry onto a positive electrode core material such as aluminum foil, followed by drying and rolling.

The positive electrode active material includes, for example, a composite oxide represented by the general formula: LiₐNi_{b}Mn_{c}Co_{d}O₂₊ₑ, where 0<a<1.3, 0.3≦b≦0.5, 0.2≦c≦0.4, 0.2≦d≦0.4, b+c+d=1, and −0.2<e<0.2. When b is equal to or more than 0.3, a sufficient battery capacity can be easily ensured. When b is equal to or less than 0.5, the gas generation due to decomposition of EC at the positive electrode can be easily suppressed. The amount of Ni in the above positive electrode active material is comparatively small. Therefore, even though W_{EC} is set relatively high, the gas generation can be sufficiently suppressed. Ni will produce NiO at the surface of the positive electrode active material. NiO facilitates the oxidative decomposition of EC.

The porosity of the positive electrode material mixture layer is preferably 10 to 20%. When the porosity of the positive electrode material mixture layer is equal to or more than 10%, the permeability of non-aqueous electrolyte can be ensured sufficiently. On the other hand, when the porosity of the positive electrode material mixture layer is equal to or less than 20%, a sufficient battery capacity can be easily ensured.

The negative electrode comprises a negative electrode core material and a negative electrode material mixture layer adhering to the negative electrode core material. The negative electrode material mixture layer contains a negative electrode active material and a binder.

The negative electrode preferably includes graphite particles as the negative electrode active material. The “graphite particles” herein collectively refer to particles having a portion with a graphite structure. Accordingly, the graphite particles include, for example, natural graphite particles, artificial graphite particles, and graphitized mesophase carbon particles.

In the case where the negative electrode active material is graphite particles, the negative electrode material mixture layer may include a water-soluble polymer which coats the surface of the graphite particles. In this case, the binder functions to bond the graphite particles coated with a water-soluble polymer. The surface of the graphite particles need not be fully coated with a water-soluble polymer, and it suffices if it is partially coated.

The inclusion of graphite particles coated with a water-soluble polymer can significantly suppress the gas generation due to reductive decomposition of PC, at the negative electrode. When graphite coated with a water-soluble polymer is used, co-intercalation of PC and solvated Li ions between the layers of graphite is unlikely to occur. As such, the destruction of the layer structure due to deterioration of the graphite edges, and the reductive decomposition of PC at the negative electrode are greatly suppressed.

The water-soluble polymer may be of any type including, without limitation: a cellulose derivative; and polyacrylic acid, polyvinyl alcohol, polyvinylpyrrolidone, and derivatives of these. Among them, a cellulose derivative and polyacrylic acid are particularly preferred. Preferred examples of the cellulose derivative include methylcellulose, carboxymethylcellulose, and Na salts of carboxymethylcellulose. The molecular weight of the cellulose derivative is preferably 10,000 to 1,000,000. The molecular weight of the polyacrylic acid is preferably 5,000 to 1,000,000.

The amount of the water-soluble polymer contained in negative electrode material mixture layer is preferably 0.5 to 2.5 parts by weight per 100 parts by weight of the graphite particles, more preferably 0.5 to 1.5 parts by weight, and particularly preferably 0.5 to 1 part by weight. When the amount of the water-soluble polymer is within the foregoing ranges, the water-soluble polymer can coat the surface of the graphite particles at a high coating rate. In addition, the surface of the graphite particles will not be excessively coated with the water-soluble polymer, and thus, the internal resistance of the negative electrode is unlikely to increase.

By coating the surface of the negative electrode active material with a water-soluble polymer having good swelling property, such as carboxymethylcellulose (CMC), the non-aqueous electrolyte including vinylene carbonate and 1,3-propane sultone can easily permeate into the interior of the negative electrode. This allows the non-aqueous electrolyte to be almost uniformly present on the surface of the graphite particles, and as a result, a uniform surface film is easily formed on the negative electrode during initial charging. This improves the charge acceptance, and favorably suppresses the reductive decomposition of PC. In short, using the non-aqueous electrolyte as described above in combination with a water-soluble polymer can greatly suppress the gas generation, as compared to using either one of them singly.

The diffraction pattern of the graphite particles measured by a wide-angle X-ray diffractometry has a peak attributed to the (101) plane and a peak attributed to the (100) plane. Here, the ratio of a peak intensity I(101) attributed to the (101) plane to a peak intensity I(100) attributed to the (100) plane preferably satisfies 0.01<I(101)/I(100)<0.25, and more preferably satisfies 0.08<I(101)/I(100)<0.2. The “peak intensity” refers to the height of a peak.

The average particle diameter of the graphite particles is preferably 14 to 25 μm, and more preferably 16 to 23 μm. When the average particle diameter is within the foregoing ranges, the slidability of the graphite particles in the negative electrode material mixture layer improves, and the packed state of the graphite particles becomes favorable, which is advantageous in enhancing the adhesion strength between the graphite particles. The “average particle diameter” refers to a median diameter (D50) in a volumetric particle size distribution of the graphite particles. The volumetric particle size distribution of the graphite particles can be measured with, for example, a commercially available laser diffraction-type particle size distribution analyzer.

The coated condition of the surface of the graphite particles with the water-soluble polymer can be evaluated on the basis of the penetration rate of water into the negative electrode material mixture layer. The penetration rate of water into the negative electrode material mixture layer is preferably 3 to 40 seconds. A negative electrode active material exhibiting such a water penetration rate is in an appropriately coated condition. As such, the non-aqueous electrolyte including the additive can easily permeate into the interior of the negative electrode. This can more favorably suppress the reductive decomposition of PC. The penetration rate of water into the negative electrode material mixture layer is more preferably 10 to 25 seconds.

The penetration rate of water into the negative electrode material mixture layer can be measured by, for example, the method as described below in a 25° C. environment.

First, 2 μL of water is dropped, to allow a water droplet to be in contact with the surface of the negative electrode material mixture layer. Then, the time period until the contact angle θ of water with respect to the surface of the negative electrode material mixture layer decreases to be less than 10° is measured to determine a penetration rate of water into the negative electrode material mixture layer. The contact angle of water with respect to the surface of the negative electrode material mixture layer may be measured with a commercially available contact angle meter (e.g., DM-301 available from Kyowa Interface Science Co., Ltd.).

For the negative electrode core material, for example, a metallic foil is used. In producing a negative electrode for lithium ion secondary batteries, for example, a copper foil or copper alloy foil is generally used as the negative electrode core material. Preferred among them is a copper foil (which may contain component(s) other than copper in an amount equal to or less than 0.2 mol %), and particularly preferred is an electrolytic copper foil.

For the separator, a microporous film made of polyethylene, polypropylene or the like is generally used. The thickness of the separator is, for example, 10 to 30 μm.

The present invention is applicable to non-aqueous electrolyte secondary batteries of various shapes, such as cylindrical shape, flat shape, coin shape, and prismatic shape, without any particular limitation to the shape of the battery.

The present invention is specifically described below with reference to examples and comparative examples. It should be noted, however, the present invention is not limited to the following examples.

### EXAMPLES

### Example 1

### (a) Production of Positive Electrode

To 100 parts by weight of LiNi_{1/3}Mn_{1/3}Co_{1/3}O₂ serving as a positive electrode active material, 4 parts by weight of polyvinylidene fluoride (PVDF) serving as a binder, and an appropriate amount of N-methyl-2-pyrrolidone (NMP) serving as a dispersion medium were added and mixed, to prepare a positive electrode material mixture slurry. The prepared positive electrode material mixture slurry was applied onto both surfaces of an aluminum foil (thickness: 20 μm) serving as a positive electrode core material by using a die coater, and the applied film was dried at 120° C. The dry applied film was then rolled with rollers, to form a positive electrode material mixture layer having a thickness of 60 μm and a porosity of 20%. The positive electrode material mixture layer was cut together with the positive electrode core material into a predetermined shape, to give a positive electrode.

### (b) Production of Negative Electrode

First, carboxymethylcellulose (CMC, molecular weight: 400,000) being a water-soluble polymer was dissolved in water, to prepare an aqueous 1 wt % CMC solution. Subsequently, 100 parts by weight of natural graphite particles (average particle diameter: 20 μm, average circularity: 0.92, specific surface area: 5.1 m²/g) and 100 parts by weight of the aqueous CMC solution were mixed together, and stirred while the temperature of the mixture was controlled at 25° C. The mixture was then dried at 150° C. for 5 hours, to give a dry mixture. In the dry mixture, the amount of CMC per 100 parts by weight of the graphite particles was 1 part by weight.

To 100 parts by weight of the dry mixture serving as a negative electrode active material, 0.6 parts by weight of a copolymer having styrene units and butadiene units (SBR) serving as a binder, and an appropriate amount of water serving as a dispersion medium were added and mixed, to prepare a negative electrode material mixture slurry. The prepared negative electrode material mixture slurry was applied onto both surfaces of an electrolytic copper foil (thickness: 12 μm) serving as a negative electrode core material by using a die coater, and the applied film was dried at 120° C. The dry applied film was then rolled with rollers, to form a negative electrode material mixture layer having a thickness of 160 μm and a graphite density of 1.65 g/cm³. The negative electrode material mixture layer was cut together with the negative electrode core material into a predetermined shape, to give a negative electrode.

### (c) Preparation of Non-Aqueous Electrolyte

LiPF₆ was dissolved at a concentration of 1 mol/L in a mixed solvent containing ethylene carbonate (EC), propylene carbonate (PC), and diethyl carbonate (DEC) at a weight ratio of 3:3:4, to prepare a non-aqueous electrolyte. To the non-aqueous electrolyte, 2 wt % of vinylene carbonate (VC) and 1 wt % of 1,3-propane sultone were added. The viscosity of the non-aqueous electrolyte at 25° C. measured with a rotational viscometer (TV-22 Viscometer, available from Toki Sangyo Co., Ltd.) was 5.3 mPa·s.

### (d) Fabrication of Battery

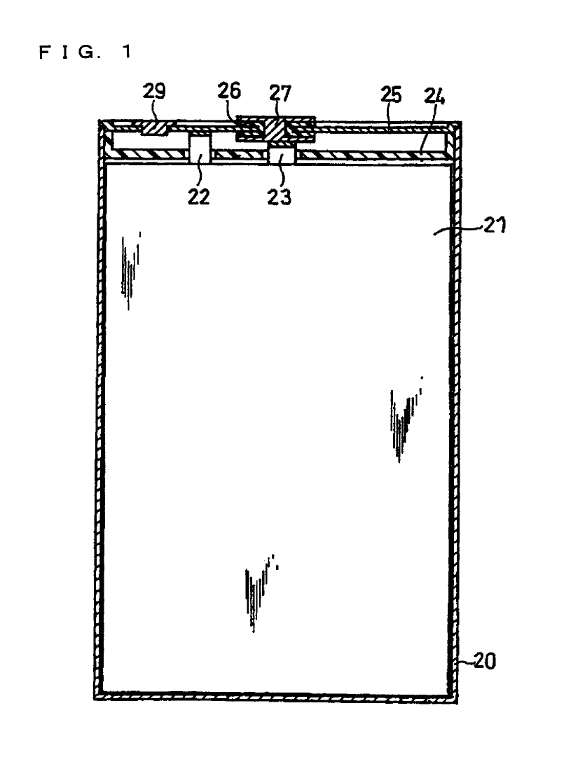

A prismatic lithium ion secondary battery as illustrated in FIG. 1 was fabricated.

The negative electrode and the positive electrode were wound with a separator of a polyethylene microporous film having a thickness of 20 μm (A089 (trade name) available from Celgard, LLC.) interposed therebetween, to form an electrode group 21 having an approximate elliptic cross section. The electrode group 21 was placed into a prismatic battery can 20 made of aluminum. The battery can 20 had a bottom and a side wall, and has an approximate square opening at the top. The main flat portion of the side wall was 80 μm in thickness. Then, an insulator 24 for preventing short circuit between the battery can 20 and a positive electrode lead 22 or a negative electrode lead 23 was disposed on top of the electrode group 21. Next, a square sealing plate 25 having at its center a negative electrode terminal 27 surrounded by an insulating gasket 26 was disposed at the opening of the battery can 20. The negative electrode lead 23 was connected to the negative electrode terminal 27. The positive electrode lead 22 was connected to the inner surface of the sealing plate 25. The edge of the opening and the sealing plate 25 were welded together by a laser, to seal the opening of the battery can 20. Subsequently, 2.5 g of the non-aqueous electrolyte was injected into the battery can 20 through an injection port of the sealing plate 25. Lastly, the injection port was closed with a sealing stopper 29 and sealed by welding, to complete a prismatic lithium ion secondary battery 1 having a height of 50 mm and a width of 34 mm, including an internal space of about 5.2 mm in thickness, and having a design capacity of 850 mAh.

<Evaluation of Battery>

### (i) Evaluation of Cycle Capacity Retention Rate

The battery 1 was subjected to the following charge/discharge cycles at 45° C. In charging of each cycle, a constant-current charge was performed at a charge current of 600 mA with a cut-off voltage of 4.2 V, and then, a constant-voltage charge was performed at 4.2 V until the current reached an end-of-charge current of 43 mA. The battery was allowed to stand for 10 minutes after charging. In discharging of each cycle, a constant-current discharge was performed at a discharge current of 850 mA with a discharge cut-off voltage of 2.5 V. The battery was allowed to stand for 10 minutes after discharging.

The discharge capacity after 500 cycles relative to the discharge capacity at the 3^{rd} cycle was calculated as a cycle capacity retention rate [%], with the discharge capacity at the 3^{rd} cycle being taken as 100%. The result is shown in Table 2.

### (ii) Evaluation of Battery Swelling

In the above evaluation (i), the thicknesses of the center portion of the battery 1 perpendicular to the largest flat surface (longitudinal length: 50 mm, lateral length: 34 mm) in the state after charging at the 3^{rd} cycle and in the state after charging at the 501^{th} cycle were measured. The difference between the measured battery thicknesses was calculated as a battery swelling amount [mm] after charge/discharge cycles at 45° C. The result is shown in Table 2.

(iii) Evaluation of Low-Temperature Discharge Characteristics

The battery 1 was subjected to three charge/discharge cycles at 25° C. In the 4^{th} charge/discharge cycle, the battery was charged at 25° C., then allowed to stand for 3 hours at 0° C., and subjected to the discharging at 0° C. The discharge capacity at the 4^{th} cycle (at 0° C.) relative to the discharge capacity at the 3^{rd} cycle (at 25° C.) was expressed as a percentage, with the discharge capacity at the 3^{rd} cycle being taken as 100%, which was defined as a low-temperature discharge capacity retention rate [%]. Here, the conditions for charging and discharging were the same as those in (i), except for the length of time during which the battery was allowed to stand after charging. The result is shown in Table 2.

### (iv) Evaluation of Battery Safety

The battery was subjected to a constant-current charge at a charge current of 600 mA with a cut-off voltage of 4.25 V, in a −5° C. environment. Thereafter, the battery temperature was elevated to 130° C. at a rate of 5° C./min, and then allowed to stand at 130° C. for 3 hours. At this time, the surface temperature of the battery was measured with a thermocouple, to determine the maximum temperature reached. The result is shown in Tale 2.

### Example 2

Non-aqueous electrolytes were prepared in the same manner as in Example 1, except that W_{EC}, W_{PC}, and W_{DEC} were changed as shown in Table 1. Batteries 2 to 14 were fabricated in the same manner as in Example 1, except that the obtained non-aqueous electrolytes were used. It should be noted that the batteries 2, 3, 7 to 9, and 14 are comparative batteries.

The batteries 2 to 14 were evaluated in the same manner as in Example 1. The results are shown in Table 2.

TABLE 1

| | W_{EC} | W_{PC} | W_{DEC} | | Viscosity |
|---|---|---|---|---|---|
| | (wt %) | (wt %) | (wt %) | W_{PC}/W_{EC} | (mPa · s) |
| (Com.) Battery 2 | 15 | 45 | 40 | 3 | 6.2 |
| (Com.) Battery 3 | 20 | 40 | 40 | 2 | 6.0 |
| Battery 4 | 21 | 39 | 40 | 1.86 | 5.8 |
| Battery 5 | 25 | 35 | 40 | 1.4 | 5.4 |
| Battery 1 | 30 | 30 | 40 | 1 | 5.3 |
| Battery 6 | 35 | 25 | 40 | 0.71 | 5.2 |
| (Com.) Battery 7 | 40 | 20 | 40 | 0.5 | 5.1 |
| (Com.) Battery 8 | 41 | 19 | 40 | 0.46 | 5.0 |
| (Com.) Battery 9 | 37.5 | 37.5 | 25 | 1 | 6.5 |
| Battery 10 | 35 | 35 | 30 | 1 | 5.8 |
| Battery 11 | 32.5 | 32.5 | 35 | 1 | 5.4 |
| Battery 12 | 27.5 | 27.5 | 45 | 1 | 5.2 |
| Battery 13 | 25 | 25 | 50 | 1 | 4.8 |
| (Com.) Battery 14 | 22.5 | 22.5 | 55 | 1 | 4.4 |

TABLE 2

| | | | Low- | |
|---|---|---|---|---|
| | | | temperature | Maximum |
| | Cycle | Swelling | discharge | surface |
| | capacity | of battery | capacity | temperature |
| | retention | after | retention | reached of |
| | rate | cycles | rate | battery |
| | (%) | (mm) | (%) | (° C.) |
| (Com.) Battery 2 | 86.6 | 0.30 | 65.1 | 173 |
| (Com.) Battery 3 | 86.2 | 0.34 | 68.7 | 144 |
| Battery 4 | 85.8 | 0.35 | 70.8 | 135 |
| Battery 5 | 84.5 | 0.39 | 72.4 | 133 |
| Battery 1 | 83.3 | 0.43 | 73.3 | 131 |
| Battery 6 | 81.4 | 0.50 | 74.5 | 131 |
| (Com.) Battery 7 | 81.0 | 0.59 | 75.0 | 131 |
| (Com.) Battery 8 | 68.5 | 1.02 | 75.2 | 131 |
| (Com.) Battery 9 | 80.7 | 0.59 | 68.4 | 145 |
| Battery 10 | 82.6 | 0.43 | 71.8 | 134 |
| Battery 11 | 85.0 | 0.34 | 73.9 | 131 |
| Battery 12 | 84.8 | 0.35 | 75.0 | 131 |
| Battery 13 | 81.5 | 0.47 | 77.6 | 131 |
| (Com.) Battery 14 | 56.1 | 1.25 | 78.2 | 131 |

Table 2 shows that in the batteries 1, 4 to 6, and 10 to 13 including a non-aqueous electrolyte having W_{EC} of more than 20 wt % and equal to or less than 35 wt %, and W_{EC} of 20 to 40 wt %, the increase in surface temperature of the battery was small. This is presumably because the amount of PC contained in the non-aqueous electrolyte was set comparatively small, and the amount of EC was increased accordingly, which suppressed lithium deposition during charging in a low temperature environment. Furthermore, in the above batteries 1, 4 to 6, and 10 to 13, the results of the cycle capacity retention rate, battery swelling after cycles, and low-temperature discharge capacity retention rate were favorable. Among them, the batteries 1, 5, 11, 12, and 13 in which W_{EC} was 25 to 33 wt %, W_{PC} was 20 to 33 wt %, and W_{DEC} was 35 to 55 wt % had well-balanced excellent characteristics.

In contrast, in the batteries 2 to 3 in which W_{EC} was equal to or less than 20 wt %, the battery 8 in which W_{EC} exceeded 35 wt %, and the battery 9 in which W_{DEC} was less than 30 wt %, the increase in surface temperature of the battery was considerably large. The battery 7 exhibited a slightly large swelling. The non-aqueous electrolytes used in these batteries have a comparatively high viscosity, which makes lithium likely to deposit on the surface of the negative electrode. Presumably because of this, sufficient heat resistance was not obtained, and gas generation was not suppressed sufficiently. In the battery 14 in which W_{DEC} exceeded 50 wt %, the amount of gas generated was large, and the cycle capacity retention rate was low.

### Example 3

Non-aqueous electrolytes were prepared in the same manner as in Example 1, except that W_{C} and W_{SL} were changed as shown in Table 3. Batteries 15 to 41 were fabricated in the same manner as in Example 1, except that the obtained non-aqueous electrolytes were used. It should be noted that the batteries 15 to 19 are comparative batteries.

The batteries 15 to 41 were evaluated in the same manner as in Example 1. The results are shown in Table 3.

TABLE 3

| | | | | | | Low- | |
|---|---|---|---|---|---|---|---|
| | | | | | Swelling | temperature | Maximum |
| | | | | Cycle | of | discharge | surface |
| | | | | capacity | battery | capacity | temperature |
| | | | | retention | after | retention | reached of |
| | W_{C} | W_{SL} | | rate | cycles | rate | battery |
| | (wt %) | (wt %) | W_{C}/W_{SL} | (%) | (mm) | (%) | (° C.) |
| (Com.) | 0 | 0 | — | charge/discharge impossible | | | |
| Battery 15 | | | | | | | |
| (Com.) | 0 | 1 | 0 | charge/discharge impossible | | | |
| Battery 16 | | | | | | | |
| (Com.) | 2 | 0 | — | charge/discharge impossible | | | |
| Battery 17 | | | | | | | |
| (Com.) | 1 | 2 | 0.5 | 65.0 | 1.08 | 73.1 | 166 |
| Battery 18 | | | | | | | |
| (Com.) | 1 | 1.5 | 0.67 | 73.4 | 0.87 | 73.0 | 150 |
| Battery 19 | | | | | | | |
| Battery 20 | 1 | 1 | 1 | 82.6 | 0.45 | 73.0 | 131 |
| Battery 21 | 1 | 0.75 | 1.33 | 81.5 | 0.48 | 73.0 | 131 |
| Battery 22 | 1 | 0.5 | 2 | 80.0 | 0.59 | 73.1 | 132 |
| Battery 23 | 1.5 | 1.5 | 1 | 82.8 | 0.45 | 73.2 | 131 |
| Battery 24 | 1.5 | 1 | 1.5 | 82.7 | 0.46 | 73.2 | 131 |
| Battery 25 | 1.5 | 0.75 | 2 | 82.6 | 0.46 | 73.3 | 131 |
| Battery 26 | 1.5 | 0.5 | 3 | 80.3 | 0.58 | 73.5 | 133 |
| Battery 27 | 2 | 1.5 | 1.33 | 83.5 | 0.41 | 73.3 | 131 |
| Battery 1 | 2 | 1 | 2 | 83.3 | 0.43 | 73.3 | 131 |
| Battery 28 | 2 | 0.75 | 2.67 | 82.2 | 0.48 | 73.5 | 131 |
| Battery 29 | 2 | 0.5 | 4 | 80.8 | 0.56 | 73.4 | 131 |
| Battery 30 | 2.25 | 1.5 | 1.5 | 83.0 | 0.43 | 73.1 | 131 |
| Battery 31 | 2.25 | 1 | 2.25 | 82.9 | 0.44 | 73.1 | 131 |
| Battery 32 | 2.25 | 0.75 | 3 | 81.6 | 0.49 | 73.5 | 131 |
| Battery 33 | 2.25 | 0.5 | 4.5 | 80.4 | 0.58 | 73.2 | 132 |
| Battery 34 | 2.5 | 1.5 | 1.67 | 82.9 | 0.43 | 73.0 | 133 |
| Battery 35 | 2.5 | 1 | 2.5 | 82.7 | 0.45 | 73.0 | 133 |
| Battery 36 | 2.5 | 0.75 | 3.33 | 81.5 | 0.49 | 73.5 | 132 |
| Battery 37 | 2.5 | 0.5 | 5.0 | 80.2 | 0.59 | 73.3 | 132 |
| Battery 38 | 3 | 1.5 | 2 | 81.1 | 0.50 | 73.2 | 134 |
| Battery 39 | 3 | 1 | 3 | 81.0 | 0.52 | 73.2 | 134 |
| Battery 40 | 3 | 0.75 | 4 | 80.7 | 0.56 | 73.3 | 133 |
| Battery 41 | 3 | 0.5 | 6 | 80.1 | 0.59 | 73.1 | 133 |

Table 3 shows that in the batteries 20 to 41 in which W_{C}/W_{SL} was 1 to 6, the increase in surface temperature of the battery was small. Furthermore, in these batteries, the results of the cycle capacity retention rate, battery swelling after cycles, and low-temperature discharge capacity retention rate were also favorable. Among them, the batteries in which W_{C} was 1.5 to 2.5 wt %, and W_{SL} was 1 to 1.5 wt % had well-balanced excellent characteristics. In contrast, with respect to the batteries 15 to 17 including neither a cyclic carbonate having a C═C unsaturated bond nor a sultone compound, it was impossible to charge and discharge the battery.

A surface film derived from the cyclic carbonate having a C═C unsaturated bond is formed on the negative electrode. The surface film can suppress the increase in the film resistance, and as a result, the charge acceptance at the negative electrode improves. Presumably because of this, the deposition of lithium during charging at low temperatures was suppressed, and the heat resistance was improved. On the other hand, a surface film derived from the sultone compound is formed on the positive and negative electrodes. The surface film can inhibit the oxidative decomposition of the non-aqueous solvent at the positive electrode and inhibit the reductive decomposition of PC at the negative electrode. Presumably because of this, the cycle capacity retention rate was improved, and the battery swelling after cycles was small.

In the batteries 18 and 19, the surface temperature of the battery was considerably increased. Presumably, in these batteries, since the amount of the sultone compound was comparatively large, an excessive amount of surface film was formed on the negative electrode. If an excessive amount of surface film is formed on the negative electrode, the charge acceptance will deteriorate, and lithium will be likely to deposit on the surface of the negative electrode during charging at low temperatures. Therefore, the heat resistance deteriorated. On the other hand, in the batteries 20 to 41 in which the amount of the sultone compound was comparatively small, an appropriate amount of surface film was presumably formed on the negative electrode. Therefore, the heat resistance was improved, while the gas generation was reduced.

### Example 4

Batteries 42 and 43 were fabricated in the same manner as in Example 1, except that the positive electrode active materials as shown in Table 4 were used.

The batteries 42 and 43 were evaluated in the same manner as in Example 1. The results are shown in Table 4.

TABLE 4

| | | | | Low- | |
|---|---|---|---|---|---|
| | | | Swelling | temperature | Maximum |
| | | Cycle | of | discharge | surface |
| | | capacity | battery | capacity | temperature |
| | | retention | after | retention | reached of |
| | Positive electrode | rate | cycles | rate | battery |
| | active material | (%) | (mm) | (%) | (° C.) |
| Battery 1 | LiNi_{1/3}Mn_{1/3}Co_{1/3}O₂ | 83.3 | 0.43 | 73.3 | 131 |
| Battery 42 | LiNi_{0.6}Mn_{0.3}Co_{0.1}O₂ | 82.6 | 0.50 | 73.3 | 132 |
| Battery 43 | LiNi_{0.80}Co_{0.15}Al_{0.05}O₂ | 80.1 | 0.59 | 73.1 | 133 |

Table 4 shows that in the batteries 1, 42 and 43, the increase in surface temperature of the battery was small. Particularly in the batteries 1 and 42 in which the positive electrode contained Ni, Mn, and Co, the battery swelling after cycling was small; and in the battery 1 in which the amount of Ni was small, the battery swelling after cycles was further small. By decreasing the amount of Ni, the production of NiO, which facilitates the oxidative decomposition of EC, can be reduced. The results indicate that even though W_{EC} is set relatively high as in the battery 1, the gag generation can be suppressed sufficiently.

### INDUSTRIAL APPLICABILITY

By using the non-aqueous electrolyte of the present invention, it is possible to provide a non-aqueous electrolyte secondary battery being excellent in the storage characteristics in a high temperature environment, heat resistance after charging in a low temperature environment, and charge/discharge cycle characteristics, and having excellent low temperature characteristics. The non-aqueous electrolyte secondary battery of the present invention is useful for cellular phones, personal computers, digital still cameras, game machines, portable audio devices, and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

20 Battery can
21 Electrode group
22 Positive electrode lead
23 Negative electrode lead
24 Insulator
25 Sealing plate
26 Insulating gasket
27 Negative electrode terminal
29 Sealing stopper

1. A non-aqueous electrolyte comprising a non-aqueous solvent, and a solute dissolved in the non-aqueous solvent, wherein:
the non-aqueous solvent contains ethylene carbonate, propylene carbonate, diethyl carbonate, and an additive;
a weight percentage W_{EC} of the ethylene carbonate to a total weight of the ethylene carbonate, the propylene carbonate, and the diethyl carbonate is more than 20 wt % and equal to or less than 35 wt %;
a weight percentage W_{PC} of the propylene carbonate to the total weight is 30 to 40 wt %;
a weight percentage W_{DEC} of the diethyl carbonate to the total weight is 30 to 50 wt %;
the additive contains a cyclic carbonate having a C═C unsaturated bond, and a sultone compound;
a ratio W_{C}/W_{SL} of a weight percentage W_{C} of the cyclic carbonate having a C═C unsaturated bond contained in the non-aqueous electrolyte, to a weight percentage W_{SL} of the sultone compound contained in the non-aqueous electrolyte is 1 to 6.

2. The non-aqueous electrolyte in accordance with claim 1, wherein a ratio W_{PC}/W_{EC} of the weight percentage W_{PC} of the propylene carbonate to the weight percentage W_{EC} of the ethylene carbonate is 0.5 to 1.75.

3. The non-aqueous electrolyte in accordance with claim 1, wherein the weight percentage W_{EC} of the ethylene carbonate is 25 to 33 wt %, the weight percentage W_{PC} of the propylene carbonate is 30 to 33 wt %, and the weight percentage W_{DEC} of the diethyl carbonate is 35 to 50 wt %.

4. The non-aqueous electrolyte in accordance with claim 1, wherein the weight percentage W_{C} of the cyclic carbonate having a C═C unsaturated bond is 1 to 3 wt %.

5. The non-aqueous electrolyte in accordance with claim 1, wherein the weight percentage W_{SL} of the sultone compound is 0.5 to 2 wt %.

6. The non-aqueous electrolyte in accordance with claim 1, wherein the weight percentage W_{C} of the cyclic carbonate having a C═C unsaturated bond is 1.5 to 2.5 wt %, and the weight percentage W_{SL} of the sultone compound is 1 to 1.5 wt %.

7. The non-aqueous electrolyte in accordance with claim 1, wherein an amount of the additive contained in the non-aqueous electrolyte is 1.5 to 5 wt %.

8. The non-aqueous electrolyte in accordance with claim 1, wherein the cyclic carbonate having a C═C unsaturated bond is vinylene carbonate.

9. The non-aqueous electrolyte in accordance with claim 1, wherein the sultone compound is 1,3-propane sultone.

10. A non-aqueous electrolyte secondary battery comprising a positive electrode, a negative electrode, a separator interposed between the positive electrode and the negative electrode, and the non-aqueous electrolyte of claim 1.

11. A non-aqueous electrolyte secondary battery comprising the battery of claim 10 which has been subjected to charging and discharging at least once.

12. The non-aqueous electrolyte secondary battery in accordance with claim 10, wherein the positive electrode includes a composite oxide represented by a general formula: LiₐNi_{b}Mn_{c}Co_{d}O₂₊ₑ, where 0<a<1.3, 0.3≦b≦0.5, 0.2≦c≦0.4, 0.2≦d≦0.4, b+c+d=1, and −0.2<e<0.2.

13. A non-aqueous electrolyte comprising a non-aqueous solvent, and a solute dissolved in the non-aqueous solvent, wherein:
the non-aqueous solvent contains ethylene carbonate, propylene carbonate, diethyl carbonate, and an additive;
a weight percentage W_{EC} of the ethylene carbonate to a total weight of the ethylene carbonate, the propylene carbonate, and the diethyl carbonate is more than 20 wt % and equal to or less than 35 wt %;
a weight percentage W_{PC} of the propylene carbonate to the total weight is 20 to 40 wt %;
a weight percentage W_{DEC} of the diethyl carbonate to the total weight is 30 to 50 wt %;
the additive contains a cyclic carbonate having a C═C unsaturated bond, and a sultone compound;
a ratio W_{C}/W_{SL} of a weight percentage W_{C} of the cyclic carbonate having a C═C unsaturated bond contained in the non-aqueous electrolyte, to a weight percentage W_{SL} of the sultone compound contained in the non-aqueous electrolyte is 1 to 6.
